(19) United States
(12) Patent Application Publication
(10) Pub. No.: US 2001/0036148 A1
(43) Pub. Date: Nov. 1, 2001

(54) Small than standard size compact disk (CD) mounted with adapter to compatibly operate on existing optical-disk type drives

(76) Inventor: Bo-In Lin, Los Altos Hills, CA (US)

Correspondence Address: Bo-In Lin, 13445 Mandoli Drive, Los Altos Hills, CA, 94022, US

(21) Appl. No.: 09/848,910

(22) Filed: May 4, 2001

Related U.S. Application Data
(60) Provisional application No. 60/202,494, filed on May 5, 2000.

(51) Int. Cl. G11B 3/70; G11B 5/84; G11B 7/26

(52) U.S. Cl. 369/289

(57) ABSTRACT

This invention discloses a multimedia system that includes a multimedia system that includes a compact-disk (CD) optical drive provided for rotationally engaging a circular-shaped disk. The multimedia system further includes an adapter for placing on the CD type drive for allowing the CD type drive to engage a pocket-sized optical disk having a smaller surface area than a normal compact-disk normally operated on the optical disk drive.

This Formal Application claims a Priority Date of May 5, 2000 benefited from a previously filed Provisional Application No. 60/202,494 filed on May 5, 2000 with an attorney docket number LC&SJ2K01 by the Applicant of this Formal Patent Application.

### BACKGROUND OF THE INVENTION

1. Field of the Invention

This invention relates generally to apparatuses and method for reading data from and writing data to flat data storage medium such as a compact disk (CD). More particularly, this invention is related to an improved system and method for reading data from and writing data to a smaller-than-normal circular flat data storage medium engaged to a normal-size circular drive with an adapter to enhance the portability of the smaller-than-normal circular storage medium.

2. Description of the Prior Art

Conventional technology of reading data from and writing data to removable-data storage medium formed on flat surfaces typically employs a disk of circular tracks. Particularly, a compact disk (CD) commonly operable with a CD-drive, i.e., optical disk drive, is now made available in almost all of the computers now sold in the market place. Typically, a CD is formed as a circular disk for storing data of approximately 650 megabytes. Similarly, digital videodisks (DVD) are also becoming more and more popular among personal computers as a commonly available multimedia device. These two kinds of drives commonly implemented in a personal computer where a DVD drive can also be used for operating on a regular CD. For the sake of simplicity such drives can be categorically designated as optical type drives since the disks for storing data operated in these drives are of the same shape and size just like that of a normal size CD. These CDs and DVDs are very useful for storing and carrying a large volume of multimedia data including audio and video data. However, these CDs and DVDs are not conveniently portable as pocket items because the CDs are slight larger than a standard sized pocket.

For this reason, Sony manufactures and market a “memory disk” to achieve the purpose of simplifying the sharing of digital content based on flash memory. The memory disk is made approximately the size of chewing gum to provide a memory of 32 megabits that is about twenty times the storage capacity of the standard 3.5″ floppy disk. The memory disks can provide interface with and between different audio/video devices now built in almost all computer systems and apparatuses such as digital cameras, camcorders. Sony's memory disks formed with 10-pin connector for inserting into a serial port to interface with the memory modules supported on a printed circuit board. Sony's memory disks are however quite expensive. A memory disk for 32 MB is now marketed at a price of almost one hundred dollars. Furthermore, it involves repeated plugging in and pulling out from a serial port. The memory disk with the connection pins may have reliability problems after long term operations.

Therefore, a need still exits for an improved storage medium formed on a planar surface that can be carried around as pocket items. The storage medium is preferably operable with existing CD or DVD drives now commonly available in a large number of computers as built-in peripheral devices. It is further desirable that such operations can be easily achieved by placing a simple non-conforming adapter, e.g., CD-disk adapter, into an existing CD-drive to read data from and write data to the pocket-sized CD memory disk.

### SUMMARY OF THE INVENTION

Therefore, an object of the present invention is to provide a low cost pocket-size data storage medium operable with existing compact disk drives commonly available in a large number of computers and multimedia systems as built-in peripheral device. The low-cost pocket-sized data-storage medium is formed with size for conveniently carrying around in a pocket such that aforementioned limitations and difficulties encountered in the prior art can be resolved.

Specifically, it is an object of the present invention to provide a novel data storage disk adapter for placing the low-cost pocket-sized data storage medium into an existing compact disk drive for reading data from and writing data to the adapted data disk. Furthermore, since the data disk are formed with a smaller size, the number of data storage tracks are only formed over the surface of a smaller circular area. Other than the compact disk adapter for placing the pocket-sized disk in the CD and/or DVD drive, no hardware modifications are required. Only a software driver is installed into a multimedia system for operating the pocket-sized data-storage disk.

Another object of the present invention is to provide a novel optical-type drive-adapter that is foldable or separable into two to four parts such that the adapter can be carried in a pocket together with the smaller-than-normal-size CD. The adapter when placed on an optical-type drive engage the circular edge of the CD type drive with a central circular area for placing the smaller-than-normal-size optical disk for operating on the standard-sized optical-type drives.

Another object of the present invention is to provide a servo-writer to write servo data on different sector of a data track of a pocket-sized optical disk. The servo data can provide identification of the circular track and number of circular tracks on the pocket sized disk such that a CD drive applies the servo data to perform data access functions only on data tracks formed over the surface area of the pocket sized CD. The servo writer can also be employed to write servo control data on the data tracks on the adapter to provide indication of available portions of data tracks for storing data.

Another object of the present invention is to provide an optical disk adapter to securely and conveniently place a pocket-sized optical disk on an optical-type drive such as the standard-sized CD and/or DVD drive. No hardware modifications are necessary. The optical disks can be compatibly operated with an existing CD and/or DVD drive by simply installing a software driver for controlling the data access operation on the pocket sized optical disk placed in a conventional CD and/or DVD drive.

Briefly, in a preferred embodiment, the present invention includes a multimedia system that includes a compact-disk (CD) optical drive provided for rotationally engaging a circular-shaped disk. The multimedia system further includes an adapter for placing on the CD type drive for allowing the CD type drive to engage a pocket-sized optical disk having a smaller surface area than a normal compact-disk normally operated on the optical disk drive.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIGS. 1A and 1B shows a top view of an optical disk and an optical disk together with a CD or DVD drive respectively of this invention;

FIGS. 2A and 2B are respectively a top view and side cross sectional view for showing the pocket-sized optical disk and optical disk adapter for placing the pocket-sized optic disks onto a CD or DVD drive; and

FIGS. 3A and 3B are top views of a foldable optical-drive adapter and a separable optical-type drive adapter separable into three parts wherein the adapter formed with data tracks for stored data therein.

### DETAILED DESCRIPTION OF THE PREFERRED EMBODIMENT

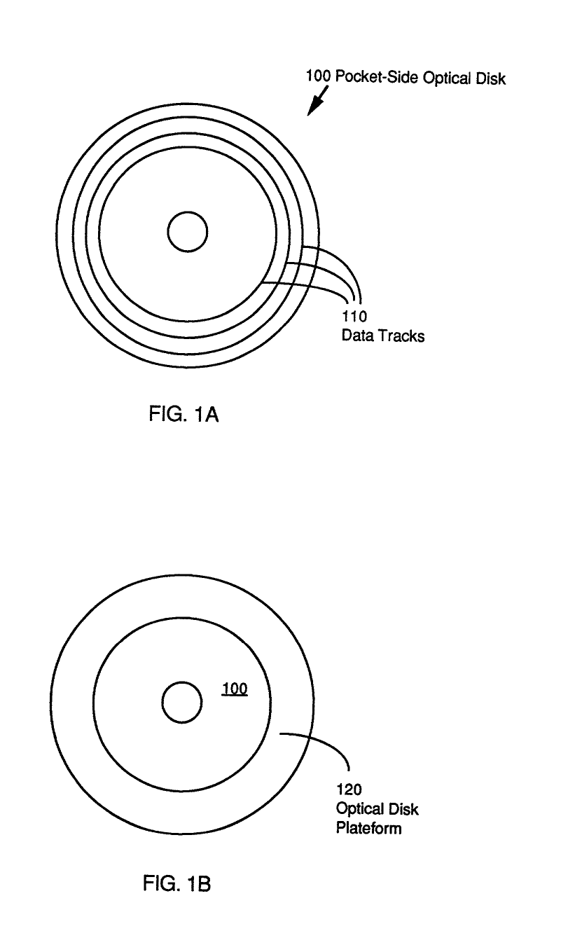

FIG. 1A shows a top view of an optical disk 100 of this invention. The optical disk is formed with a plurality of optical data-tracks each formed as data-storage arc 110 distributed over the surface of the optical disk. FIG. 1B shows the relative size and position of the optical disk 100 when placed on a rotating platform 120 of a conventional compact disk (CD) drive. For the purpose of compatibly operating with a CD and/or DVD drive, the data storage arcs 110 are formed as concentric arcs conforming to the conventional data track configuration. A pickup head of a conventional CD and/or DVD drive in reading data from and writing data to these data storage arcs would operate the same way mechanically as if the CD and/or DVD drive is operating over a conventional CD and/or DVD. The differences are the signal and data processes performed on the data reading from and writing to different portion over different portions of the surface area. The details will be further described below.

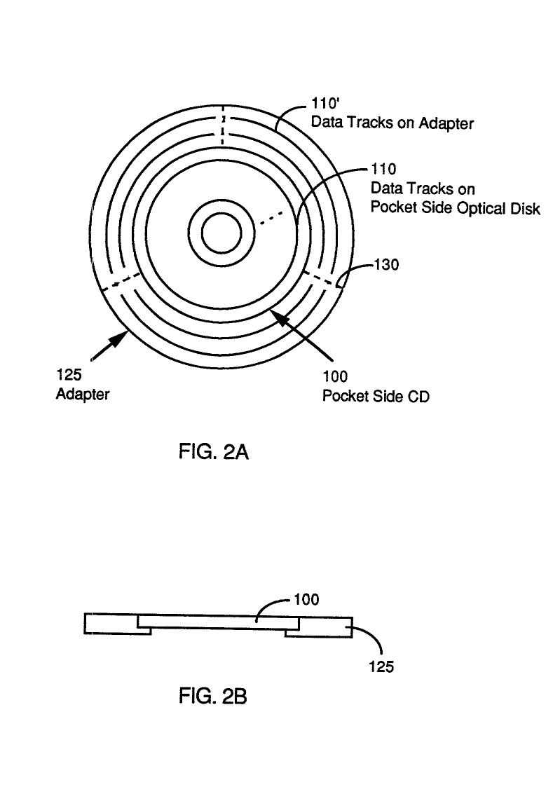

FIGS. 2A and 2B are respectively a top view and a cross sectional view of a compact disk (CD) drive disk-adapter 125 adapting a smaller-than-normal-size optical disk 100 on an optical type drive, e.g., CD and/or DVD drive, for placing on and operated by a conventional CD and/or DVD drive. The disk adapter 125 is formed with three separable parts where each part also includes data tracks 110′ for storing data. The adapter 125 is formed with a central circular area for placing the smaller-than-normal-size optical disk 100. The adapter 125 has a outer diameter identical to a normal size optical disk. The optical-type disk adapter 125 thus has an outer circular edge engages the inner circular edge of the rotational platform of the CD and/or DVD drive. The disk adapter 125 further has an optical disk placement seat 125-S for placing and securely seating the optical disks 100 in the seat. As shown in FIG. 2B, the optical-disk placement seat 125-S is formed with lower surfaces relative to the top surface of the optical-type disk adapter 125. With the optical-drive disk-adapter 125, the optical disks 100 can be placed on an existing CD and/or DVD drive without other additional hardware modifications. A commonly available CD and/or DVD drive can be used to read and write the smaller-than-normal-size optical disks 100 that can be conveniently carried around in a pocket.

The material compositions and method of manufacturing the optical disk would be substantially the same as making a regular compact disk (CD). The recording medium layer can be formed by a process identical to that of an optical compact-disk (CD), CDR, read-write CD (RW-CD), or digital video display (DVD) disks that may be compatibly operated by different types of CD and/or DVD drives according to conventional techniques. The optical disk can be formed with standardized sizes of approximated three inches to four inches in diameter for conveniently placing into a pocket to carry around. The data-track are basically concentric circular tracks just like regular CDs. These data tracks can be formatted to include plurality of sectors with particular sectors specially designated for providing servo data to identify the track and length of the circular tracks and to enhance the data access operations of the pickup head. The formats of the data track and the operation of the data access by the pickup head of the CD and/or DVD drive over these data tracks would be identical to those of standard size optical disks. For reading or writing data on the optical disks, an optical disk software driver has to be installed into a multimedia device, such as a person computer to retrieve data essentially from the pocket size CD 120 that is smaller than a standard size CD. The driver software is applied to control and operate the CD and/or DVD drive when an optical disk 120 is placed in the CD and/or DVD drive with an adapter 125.

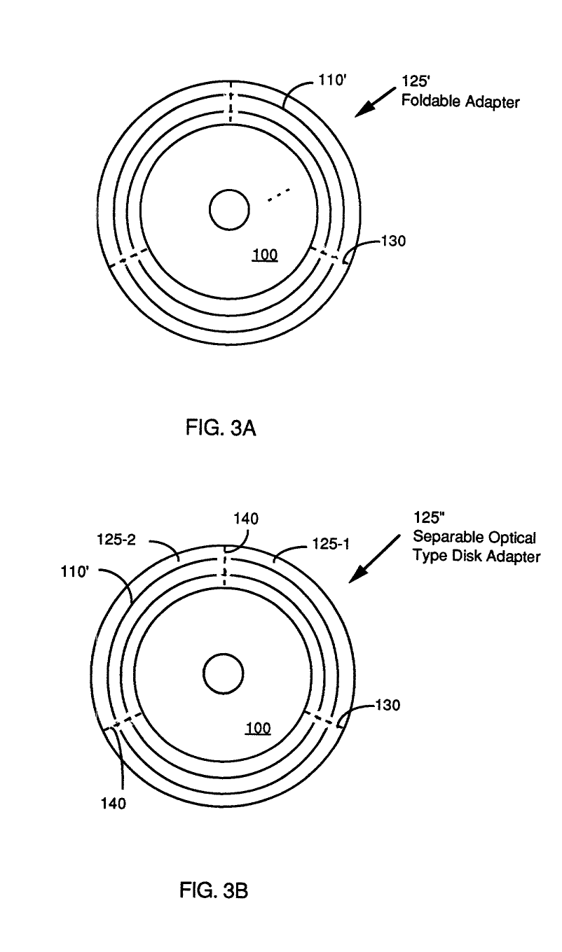

Referring to FIGS. 3A and 3B for the circular donut shaped adapter 125. FIG. 3A shows a foldable adapter that has folding linkage 130 to fold the adapter 125′ into a smaller folded adapter that can then be placed into a pocket size package sold together with the smaller-than-normal sized optical disk 120. The folded adapter 125′ further includes data tracks 110′ formed on the surface areas of the foldable adapter 125′. The data track 110′ are formed in surface area at a small distance away from the folding linkage 130′. The data tracks 110′ can be employed to store data as advertisement for promoting multimedia products such as music CDs or movies that related to the multimedia data, e.g., musical data, stored in the data tracks of the smaller-than-normal sized optical disk 120. FIG. 3B shows another embodiment of the adapter that can be separated into three smaller separated adapter parts 125-1, 125-2, and 125-3. These separated parts can be packaged together with the smaller-than-normal sized optical disk 120 as a pocket-size package. Again, the separable adapter 125′ also includes data tracks 110′ for storing data related to the multimedia data stored in the data tracks 110 formed on the smaller-than-normal optical disk 120. Servo data can be written to these data tracks to provide indications of the length of the track. The pickup head can ignore the sections where the data tracks are interrupted by the folding linkage 130 or around the edges of the separable adapter pieces, e.g., near the edges 140 of the adapter parts 125-1, 125-2, and 125-3.

Therefore, according to FIGS. 1A to 2B, this invention discloses a multimedia system that includes an optical-disk type of drive provided for rotationally engaging a circular-shaped disk. The multimedia system further includes an adapter 125 for placing on the optical-disk type drive for allowing the CD type drive to engage a circular planar data storage medium 100 of a smaller size than the circular-shaped disk. In a preferred embodiment, the adapter 125 is a foldable adapter. In another embodiment, the adapter comprises multiple separable parts, e.g., 125-1, 125-2, and 125-3 for forming a circular adapter with a central open area provided for placing the pocket size optical disk 120 therein.

The invention also discloses an adapter for placing on an optical-type drive of a multimedia system. The adapter includes a circular donut shape surface having a circular edge for engaging the CD-type drive for rotating with the CD-type drive. The adapter further includes a central circular opening for placing a smaller-than-normal-sized circular planar data storage medium for allowing the optical-type drive to carry out a data access over the smaller-than-normal-sized circular planar data-storage medium. In a preferred embodiment, the central circular opening has a diameter between about three to four inches. In a preferred embodiment, the adapter further includes at least a foldable linkage for folding the adapter into a smaller folded adapter. In another preferred embodiment, the adapter further includes at least two adapter parts for assembling into the circular donut shape surface.

This invention also discloses a pocket size package that a smaller-than-normal sized circular data storage medium. The package further contains a folded adapter for placing on a normal sized optical disk drive having a central circular opening for placing the smaller than normal sized circular data storage medium for accessing data stored therein. In a preferred embodiment, the folded adapter further has a plurality of data tracks for storing multimedia data therein for advertising products related to multimedia data stored in the smaller-than-normal sized circular data storage medium. In another preferred embodiment, the package contains an adapter comprising multiple adapter pieces for placing on a normal sized optical disk drive to form a donut-shape circular surface having a central circular opening for placing the smaller than normal sized circular data storage medium for accessing data stored therein. In another preferred embodiment, the multiple-part donut-shape circular surface of the adapter further having a plurality of data tracks for storing multimedia data therein for advertising products related to multimedia data stored in the smaller-than-normal sized circular data storage medium.

Therefore, the present invention discloses a low cost data storage disk operable with existing compact disk drives commonly available in a large number of computers and multimedia systems as built-in peripheral device. The data-storage disk is formed with a smaller size, e.g., approximately three to four inches in diameter, for conveniently carrying around in a pocket such that the limitations and difficulties encountered by conventional memory disks and compact disks (CDs) for multimedia applications can be resolved. Specifically, this invention provides a novel data storage disk and a compact disk adapter for placing the data storage disk into an existing compact disk drive for reading data from and writing data to the adapted data disk. Furthermore, since the data disks are formed with smaller than standard size, the data disk is provided with concentric data storage tracks in a smaller area than the standard size disks. Other than the compact disk adapter for placing the data storage disk in the CD and/or DVD drive, there is no modification of hardware required. Only a software driver is installed into a multimedia system for operating the data-storage disk. A servo-writer is employed to write servo data on different sector of the data track of the pocket size optical disk. The servo data can provide identification of the track, the length, and the data types at different sectors on the data tracks such that data access time for performing multimedia functions can be shortened. An optical disk adapter is now employed to securely and conveniently place a smaller than standard size optical disks on a CD and/or DVD drive. The smaller than standard size optical disks can be compatibly operated with an existing CD and/or DVD drive by simply installing a software driver for controlling the data access operation on the data disks placed in a conventional CD and/or DVD drive.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A multimedia system comprising:
an optical compact-disk (CD) drive provided for rotationally engaging a circular-shaped disk;
an adapter for placing on said CD drive for allowing said CD drive to engage and rotationally drive a smaller-than-normal-sized circular data storage medium for performing a data access thereon.

2. The multimedia system of claim 1 wherein:
said adapter is a donut-shaped adapter substantially circular in shape having a central opening for placing on said CD drive to engage said smaller-than-normal-sized circular data storage medium in said central-opening.

3. The multimedia system of claim 2 wherein:
said central-opening of said donut-shaped adapter is substantially a circular central opening comprising an engaging edge for securely engaging said smaller-than-normal-sized circular data storage medium.

4. The multimedia system of claim 1 wherein:
said adapter having a foldable linkage for folding into a folded adapter for providing a pocket-size portability.

5. The multimedia system of claim 1 wherein:
said adapter comprises several adapter-pieces for separating into several pocket portable adapter pieces.

6. The multimedia system of claim 1 wherein:
said adapter further comprises several concentric data tracks for storing data therein.

7. The multimedia system of claim 4 wherein:
said adapter further comprises several concentric data tracks for storing data, said data tracks formed on surface area of said adapter away from said folding linkage.

8. The multimedia system of claim 5 wherein:
said adapter further comprises several concentric data tracks for storing data, said data tracks formed on surface area of said adapter away from edges of said adapter pieces.

9. The multimedia system of claim 1 wherein:
said smaller-than-normal sized planar data storage medium further having a plurality of concentric data-tracks for storing data therein.

10. The multimedia system of claim 7 wherein:
each of said plurality of concentric data tracks on said adapter planar data storage medium further having a sector for storing servo data provided for aiding access to data stored in said data tracks on said adapter.

11. The multimedia system of claim 8 wherein:
each of said plurality of concentric data tracks on said adapter planar data storage medium further having a sector for storing servo data provided for aiding access to data stored in said data tracks on said adapter.

12. An adapter for placing on an optical-type drive of a multimedia system comprising:
a circular donut shape surface having a circular edge for engaging said CD-type drive for rotating with said CD-type drive; and
a central circular opening for placing a smaller-than-normal-sized circular planar data storage medium for allowing said optical-type drive to carry out a data access over said smaller-than-normal-sized circular planar data-storage medium.

13. The adapter of claim 12 wherein:
said central circular opening has a diameter between about three to four inches.

14. The adapter of claim 12 further comprising:
at least a foldable linkage for folding said adapter into a smaller folded adapter.

15. The adapter of claim 12 further comprising:
at least two adapter parts for assembling into said circular donut shape surface.

16. A pocket size package containing:
a smaller-than-normal sized circular data storage medium; and
a folded adapter for placing on a normal sized optical disk drive having a central circular opening for placing said smaller than normal sized circular data storage medium for accessing data stored therein.

17. The pocket-size package wherein:
said folded adapter further having a plurality of data tracks for storing multimedia data therein for advertising products related to multimedia data stored in said smaller-than-normal sized circular data storage medium.

18. A pocket size package containing:
a smaller-than-normal sized circular data storage medium; and
an adapter comprising multiple adapter pieces for placing on a normal sized optical disk drive to form a donut-shape circular surface having a central circular opening for placing said smaller than normal sized circular data storage medium for accessing data stored therein.

19. The pocket-size package wherein:
said donut-shape circular surface of said adapter further having a plurality of data tracks for storing multimedia data therein for advertising products related to multimedia data stored in said smaller-than-normal sized circular data storage medium.
